(19) United States
(12) Patent Application Publication
(10) Pub. No.: US 2026/0225119 A1
(43) Pub. Date: Aug. 6, 2026

(54) TUBE-END SPRAYER

(71) Applicant: Shaoping SUN, Shenzhen (CN)

(72) Inventor: Shaoping SUN, Shenzhen (CN)

(21) Appl. No.: 19/059,330

(22) Filed: Feb. 21, 2025

(30) Foreign Application Priority Data
Feb. 5, 2025 (CN) 202520181561.X

(51) Int. Cl. B05B 7/26; B05B 1/30

(52) U.S. Cl. CPC B05B 7/26; B05B 1/3026

(57) ABSTRACT

Disclosed in the invention is a tube-end sprayer, including a spray outlet provided with a liquid mixing chamber, where the liquid mixing chamber has an output port facing an output port of the spray outlet, one input port communicating with an electric pump, and the other input port communicating with a flow valve, the flow valve communicates with a hose that delivers a diluted liquid, and the electric pump communicates with a liquid container that holds a preparation. The preparation and the diluted liquid are mixed in the liquid mixing chamber to form a preparation solution, and the preparation solution is sprayed out of the spray outlet under the impact of subsequent delivery of the preparation and the diluted liquid, thus achieving outward delivery of the preparation solution.

### TECHNICAL FIELD

The present invention relates to the technical field of garden and agricultural machinery, more specifically, to a tube-end sprayer.

### BACKGROUND

In the fields of gardening and agriculture, sprayers are important working tools. For the prevention and control of plant diseases and pests, the sprayers are frequently used to spray pesticides in order to protect flowers and trees from pest infestations and pathogen infections. Moreover, the requirements for pesticide concentration and spraying volume vary in different seasons and plant growth stages. The sprayers are also commonly used in fertilization operations to evenly spray liquid fertilizers, thus promoting plant growth. When nutrients are supplemented for crops, spraying the liquid fertilizers such as foliar fertilizers with the sprayers can improve the fertilizer utilization and enhance the stress resistance of the crops.

A conventional sprayer structurally includes a liquid storage container, a pressure system (e.g., a pump), a spray nozzle, a conduit, a trigger (e.g., a switch), a flow regulator, and the like. After a solution to be sprayed is prepared, it is placed in the liquid storage container. When the trigger is activated, the pressure system starts working to pump the solution from the liquid storage container, and the solution is delivered through the conduit to the spray nozzle and is sprayed out from the spray nozzle. The flow regulator can be disposed in the pressure system, the conduit, the spray nozzle, and other locations to control the flow velocity (or the outward spraying volume) of the solution inside the sprayer. However, the pre-prepared solution has a problem of effectiveness, and the operation in the preparation process is also complex and cumbersome. In addition, such a sprayer has high requirements for the capacity of the liquid storage container.

### SUMMARY

To overcome the deficiency that the existing sprayer requires pre-preparation of a solution, the present invention provides a tube-end sprayer.

A technical solution of the present invention is as follows:

A tube-end sprayer, including a spray outlet provided with a liquid mixing chamber, where the liquid mixing chamber has an output port facing an output port of the spray outlet, one input port communicating with an electric pump, and the other input port communicating with a flow valve, the flow valve communicates with an input end that delivers a diluted liquid, and the electric pump communicates with a liquid container that holds a preparation.

In the above tube-end sprayer, the electric pump is a metering pump.

In the above tube-end sprayer, flow directions of liquids flowing into the liquid mixing chamber through the two input ports are perpendicular to each other.

In the above tube-end sprayer, the electric pump is disposed above the spray outlet, and the liquid container that holds the preparation is disposed below the spray outlet.

In the above tube-end sprayer, a liquid accommodation chamber of the electric pump is disposed at a lower part, and a driving portion of the electric pump is disposed at an upper part.

In the above tube-end sprayer, an end part of the tube-end sprayer connected to the hose is provided with a first plug, and the first plug is connected to a nut.

In the above tube-end sprayer, an end part of the tube-end sprayer connected to the liquid container is provided with a second plug, and the second plug is connected to a nut.

In the above tube-end sprayer, the flow valve is provided with a valve handle that controls an opening degree of a flow passage of the flow valve, and the valve handle is connected to a valve element of the flow valve.

In the above tube-end sprayer, a rotating portion of the valve handle is provided with a toggle rod extending outwards, a tail end of the toggle rod abuts against a microswitch that controls the electric pump, and the microswitch has a fixed end and a movable end.

In the above tube-end sprayer, the microswitch that controls the electric pump is connected to a battery.

In the above tube-end sprayer, one end of the spray outlet is provided with a long-handled pipeline connected to an output end of the flow valve, so that the output end of the flow valve communicates with the liquid mixing chamber.

The present invention according to the above solution has the following beneficial effects:
1. The electric pump that delivers the preparation is the metering pump, which delivers a fixed amount of liquid per unit time. The delivery volume of the diluted liquid can be precisely controlled by controlling the opening degree of the flow valve. In the same time, the mixing amount of the preparation and the diluted liquid is constant, thus achieving preparation of preparation solutions with different ratios and concentrations. These solutions can be prepared and used immediately.
2. The electric pump can pump liquids with high viscosity or liquids containing fine particles. Compared with manual pumps, it performs better in terms of power and liquid adaptability.
3. The flow directions of the liquids flowing into the liquid mixing chamber through the two input ports are perpendicular to each other, so that when the preparation and the diluted liquid enter the liquid mixing chamber, they immediately impact each other to form complex cross-flow path and flow field, thereby accelerating the liquid dispersion process, ensuring more thorough mixing, breaking up impurities or lumps in the liquids, and reducing the risk of blocking the liquid mixing chamber or subsequent pipelines.
4. The electric pump is disposed above the liquid container that holds the preparation, and the electric pump has the liquid accommodation chamber located at the lower part and the driving portion located at the upper part. Such a layout prevents the liquid from flowing back into the electric pump, reduces the risk of leakage and damage to the electric pump, and helps to reduce the pressure loss at a suction end of the electric pump. It also enables conversion of kinetic energy into potential energy and intensifies the impact in the liquid mixing chamber.
5. The opening degree of the flow valve is controlled by the valve handle, which can change the flow rate of the diluted liquid entering the liquid mixing chamber. Consequently, different concentrations of mixed solutions can be prepared based on quantitative delivery of the preparation by the electric pump. Meanwhile, the toggle rod disposed at the rotating portion of the valve handle cooperates with the microswitch that controls the electric pump to ensure that the inflow of the diluted liquid and the pumping of the preparation by the electric pump start and stop simultaneously, so that the liquid delivered from the spray outlet is always the preparation solution.

### BRIEF DESCRIPTION OF THE DRAWINGS

To more clearly illustrate the technical solutions in the embodiments of the present invention, the accompanying drawings that need to be used in the description of the embodiments or the prior art will be briefly introduced below. Apparently, the accompanying drawings in the description below merely illustrate some embodiments of the present invention. Those of ordinary skill in the art may also derive other accompanying drawings from these accompanying drawings without creative efforts.

FIG. 1 is a schematic diagram of an external structure of a tube-end sprayer;

FIG. 2 is a schematic structural diagram of a spray outlet of a tube-end sprayer;

FIG. 3 is a first schematic diagram of an internal structure of a tube-end sprayer;

FIG. 4 is a second schematic diagram of an internal structure of a tube-end sprayer; and

FIG. 5 is a schematic exploded view of a partial structure of a tube-end sprayer.

In the drawings, reference signs are as follows:
1. housing; 11. first plug; 12. second plug; 13. nut; 14. movable plate;
2. spray outlet; 21. liquid mixing chamber; 22. transverse partition plate; 23. long-handled pipeline;
3. electric pump; 31. input pipeline; 32. output pipeline; 33. micro switch;
4. flow valve; 41. valve handle; 42. valve element; 43. toggle rod;
5. electric wire; and 51. battery.

### DETAILED DESCRIPTION OF THE EMBODIMENTS

To make the technical problems to be solved by the present invention and the technical solutions and beneficial effects of the present invention clearer, the present invention will be further described in detail below with reference to the accompanying drawings and the embodiments. It should be understood that the specific embodiments described herein are only used to explain the present invention, rather than to limit the present invention.

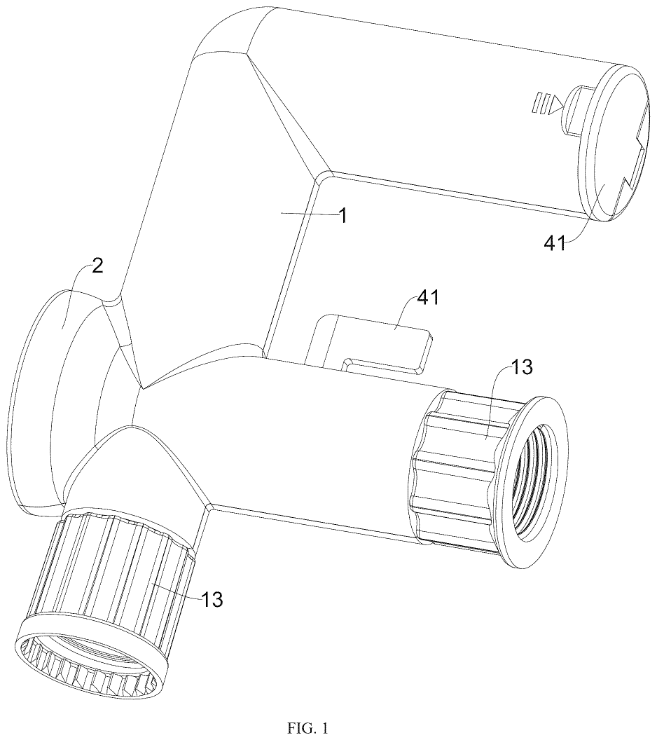

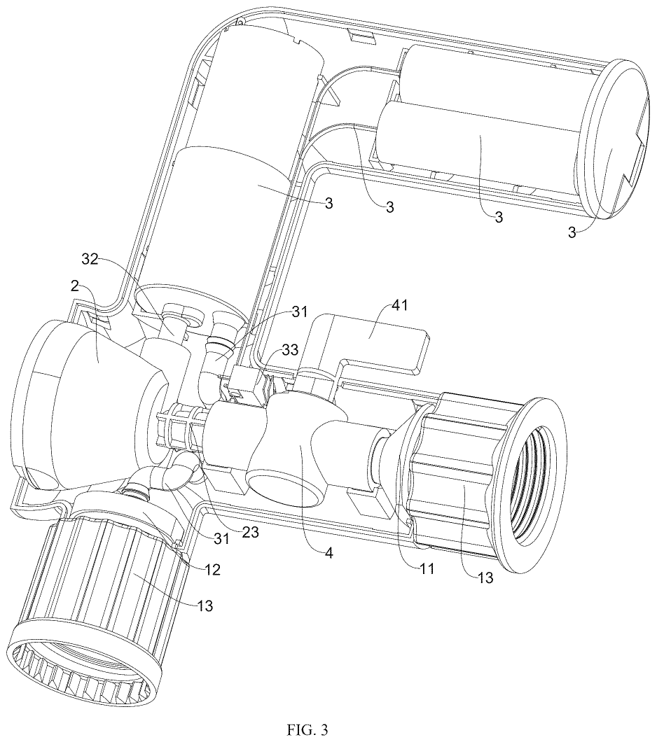

A tube-end sprayer, as shown in FIG. 1 and FIG. 3, includes a spray outlet provided with a liquid mixing chamber, where the liquid mixing chamber has an output port facing an output port of the spray outlet, one input port communicating with an electric pump, and the other input port communicating with a flow valve, the flow valve communicates with a hose that delivers a diluted liquid, and the electric pump communicates with a liquid container that holds a preparation.

The electric pump pumps out the preparation from the liquid container and delivers it through a pipeline into the liquid mixing chamber of the spray outlet, and meanwhile, the flow valve connected to the hose is opened for inputting the diluted liquid to the liquid mixing chamber of the spray outlet. The preparation and the diluted liquid are mixed in the liquid mixing chamber to form a preparation solution, and the preparation solution is atomized and sprayed out of the spray outlet under the impact of subsequent delivery of the preparation and the diluted liquid, thus achieving outward delivery of the preparation solution.

In this embodiment, the preparation is a chemical for gardening or agriculture, such as a pesticide, an insecticide, or a fertilizer, and the diluted liquid is tap water. In other embodiments, the diluted liquid may be any liquid with a low concentration, including the above pesticide, insecticide, etc.

The electric pump is a metering pump. The metering pump delivers the liquid by periodically changing the volume of a working chamber. The amount (flow rate) of liquid delivered per unit time is fixed and independent of changes in pipeline pressure. Due to the stable flow rate of the electric pump, precise control of the fluid delivery volume and accurate addition of a specific dose of the preparation can be achieved. In the present disclosure, since the amount of the preparation pumped once by the electric pump is fixed, preparation solutions with different ratios and concentrations can be prepared by only controlling the diluted liquid inputted to the liquid mixing chamber through the flow valve.

The electric pump may be any one of a diaphragm pump, a peristaltic pump, and a gear pump.

In addition, the electric pump can pump liquids with high viscosity or liquids containing fine particles. Compared with manual pumps, the electric pump performs better in terms of power, adaptability, etc.

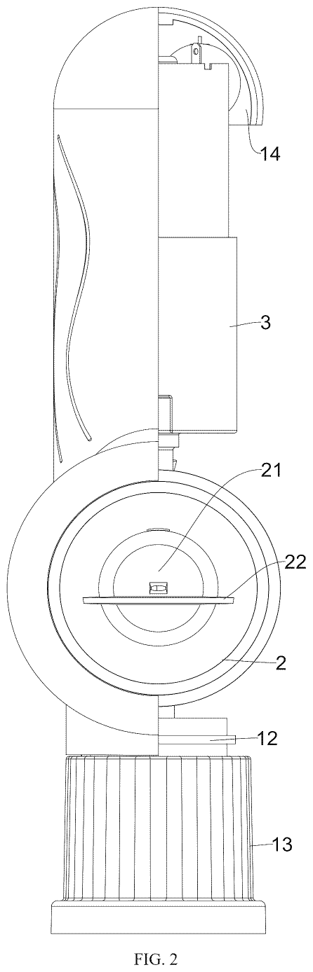

As shown in FIG. 2, flow directions of liquids flowing into the liquid mixing chamber through the two input ports are perpendicular to each other.

A small-diameter end of the spray outlet is disposed inside the sprayer and is an end surface in a closed state, and a large-diameter end of the spray outlet faces outwards and is an opening in an opened state. The liquid mixing chamber is located inside the trumpet-shaped spray outlet and is close to the end surface of the spray outlet. The liquid mixing chamber is formed by a partition plate disposed inside the spray outlet. A transverse partition plate is disposed inside the spray outlet. The transverse partition plate is located in the center of the spray outlet, spans transversely across two sides of the spray outlet, and extends inwards to the end surface of the spray outlet. In this way, a space located above the transverse partition plate and below an inner top surface of the spray outlet, and in which the end surface of the spray outlet faces outwards forms the liquid mixing chamber. Inside the liquid mixing chamber, the end surface of the spray outlet is provided with two input ports. In this embodiment, the end surface of the spray outlet is provided with an input port communicating with the hose (the input port communicating with the hose is disposed above the transverse partition plate), and the inner top surface of the spray outlet is provided with an input port communicating with the electric pump. The preparation delivered by the electric pump flows into the liquid mixing chamber from top to bottom, and the diluted liquid delivered by the hose flows into the liquid mixing chamber from inside to outside, so that the preparation and the diluted liquid enter the liquid mixing chamber in the perpendicular flow directions.

The perpendicular flow directions of the preparation and the diluted liquid cause the two liquids to impact each other immediately when they enter the liquid mixing chamber (a limited and relatively small space), so that the two liquids form a complex cross-flow path in the liquid mixing chamber and are converged and mixed for multiple times, thus accelerating the liquid dispersion process, and ensuring more thorough liquid mixing. Meanwhile, when the liquids flow into the liquid mixing chamber perpendicularly, they impact each other to generate a large impact force and form a complex flow field. This can break up impurities or lumps in the liquids or impact deposited impurities in the liquid mixing chamber, and reduce the risk of blocking the liquid mixing chamber or subsequent pipelines.

In addition, the input port communicating with the hose and disposed on the end surface of the spray outlet is in an enlarged shape. Specifically, the input port communicating with the hose and disposed on the end surface of the spray outlet is a nozzle, one side of the nozzle close to the hose is of an elliptical structure with a small area, one side of the nozzle close to the liquid mixing chamber is of a rectangular structure with a large area, and two side surfaces of the nozzle are triangular. In this way, the diluted liquid flowing from an end of the hose through the flow valve and a long-handled pipeline of the spray outlet is sprayed into the liquid mixing chamber in a fan-shaped manner, thus increasing the area of contact with the preparation, and intensifying convergence and mixing in the liquid mixing chamber.

The electric pump is disposed above the spray outlet, and the liquid container that holds the preparation is disposed below the spray outlet.

The electric pump pumps the preparation from the liquid container through an input pipeline, and the preparation is delivered to the inside of the electric pump located above the spray outlet. Under the action of the electric pump, the preparation is delivered from top to bottom through an output pipeline to the inside of the liquid mixing chamber in the spray outlet. A liquid accommodation chamber of the electric pump is disposed at a lower part and is close to the spray outlet. A positional relationship among the electric pump, the liquid container, and the spray outlet prevents the liquid from flowing back into the electric pump. Whether during the process of pumping the preparation or when the preparation flows into the spray outlet, if the operation of the electric pump stops, the liquid will not flow back into the electric pump under the effect of gravity. This reduces the leakage risk of the electric pump and avoids the damage to the electric pump. In addition, such a positional arrangement helps to reduce the pressure loss at a suction end of the electric pump. Kinetic energy of the electric pump that pumps the preparation is converted into potential energy of the preparation, and impact of the preparation is intensified when it flows into the spray outlet.

A liquid accommodation chamber of the electric pump is disposed at a lower part, and a driving portion of the electric pump is disposed at an upper part. The preparation in the liquid container is pumped upwards from the bottom into the liquid accommodation chamber of the electric pump. To avoid unnecessary power waste and reduce the requirement for a driving force of the electric pump, the pumping distance from the liquid container should not be too long and should be as close to the spray outlet as possible. Therefore, the liquid accommodation chamber of the electric pump is disposed below the driving portion of the electric pump. In addition, such a positional structure in which the liquid accommodation chamber of the electric pump is disposed below the driving portion of the electric pump is beneficial for pipeline layout in the tube-end sprayer, shortens the length of the pipelines inside the tube-end sprayer, and reduces the risks or adverse effects of leakage, interference, excessive weight, and the like.

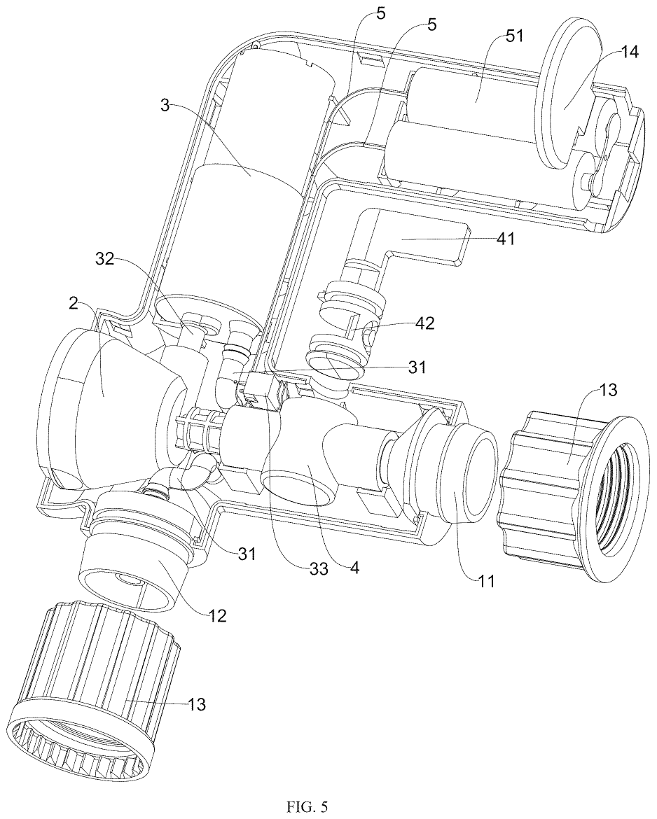

As shown in FIG. 3 and FIG. 5, an end part of the tube-end sprayer connected to the hose is provided with a first plug, and the first plug is connected to a nut. An end part of the tube-end sprayer connected to the liquid container is provided with a second plug, and the second plug is connected to a nut.

A housing of the tube-end sprayer is provided with an opening in an end part connected to the hose or the liquid container, and a plug is disposed at the opening to fix the nut. All the plugs have a structure with a through hole inside. The through hole of the first plug communicates with the input pipeline of the electric pump, and the through hole of the second plug communicates with an input port of the flow valve. An outer end surface of the plug has a section in interference fit assembly with the opening in the end part of the housing. A section of the outer end surface of the plug is provided with a concave mounting groove, and an opening in an end surface of the nut is formed on the mounting groove, so that the connection between the nut and the plug is achieved, and the nut abuts against and contacts with the end part of the housing. Meanwhile, a contraction structure at the end part of the tube-end sprayer is connected to the mounting groove, and a circular soft rubber is disposed for sealing, so that the nut and the plug together block the opening in the end part of the housing.

The inside of the plug is of a hollow structure for delivering the preparation or the diluted liquid. For the first plug at a joint between the tube-end sprayer and the hose, an end close to the flow valve is funnel-shaped, a small-diameter end communicates with a liquid inlet of the flow valve, and a large-diameter end communicates with an internal space of the nut. A thread on an inner surface of the nut is in assembly connection with a thread of a structure at the end part of the hose, so that the nut is connected to the hose, and the diluted liquid delivered through the hose flows into the flow valve through the hose, the nut, and the first plug. A flow passage is formed in the center of the second plug at a joint between the tube-end sprayer and the liquid container. One end of the flow passage is connected to the input pipeline connected to the suction end of the electric pump, and the other end of the flow passage passes through the opening of the nut and communicates with the internal space of the nut. A thread on an inner surface of the nut is in assembly connection with a thread on an opening surface of the liquid container, so that the preparation in the liquid container flows into the electric pump through the nut, the second plug, and the input pipeline.

The presence of the nut makes it convenient to achieve communication of flow passages among the tube-end sprayer, the hose, and the liquid container, and can ensure a certain degree of sealing. The presence of the plug not only can enable the nut to be fixed to the end part of the housing of the tube-end sprayer, but also can play a role in blocking and sealing the tube-end sprayer.

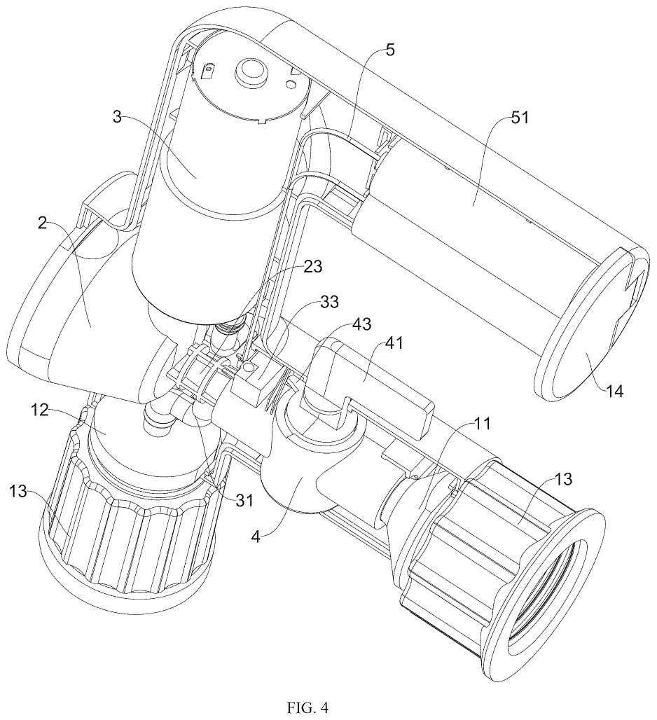

As shown in FIG. 3, FIG. 4, and FIG. 5, the flow valve is provided with a valve handle, and the valve handle penetrates through the housing of the tube-end sprayer and is disposed outside the housing of the tube-end sprayer.

The flow valve controls the flow rate by changing the flow area or flow length of a valve port to alter the liquid resistance. An input end and an output end of the flow valve are flow passages communicating with each other, and a valve element is disposed between the input end and the output end. A through hole is formed in the center of the valve element. When the flow valve is closed, the through hole in the center of the valve element is perpendicular to the flow passage between the input end and the output end of the flow valve, so that the flow passage between the input end and the output end of the flow valve is in a blocked state. The valve element rotates together with the valve handle of the valve, and the through hole in the center of the valve element rotates and gradually tends to be in the same direction as the flow passage between the input end and the output end of the flow valve. During the process when the valve handle rotates by 0-45°, the larger the rotation angle of the valve handle is, the larger the area of communication between the through hole in the center of the valve and the flow passage between the input end and the output end of the flow valve is. This leads to an increase in the flow rate of the diluted liquid entering the flow valve. According to the principle of fluid mechanics, when a fluid flows through the valve, rotation of the valve element changes the flow area of the valve port, thereby affecting the flow velocity and flow rate of the fluid.

The valve handle of the flow valve controls an opening degree of the flow valve. That is, when the flow velocity of the diluted liquid flowing into the flow valve is constant, the flow rate of the diluted liquid is controlled, and the flow rate of the diluted liquid flowing into the liquid mixing chamber of the spray outlet is also controlled. Since the amount of the preparation flowing into the liquid mixing chamber through the metering pump is constant, controlling the opening degree of the flow valve by the valve handle means controlling the amount of the diluted liquid mixed with the preparation to prepare mixed solutions with different concentration requirements.

As shown in FIG. 5, a handle end of the valve handle is disposed outside the housing of the tube-end sprayer for a user to rotate. Since the valve handle is coaxially connected to the valve element of the flow valve, when the user holds the valve handle and rotates it, the valve element of the flow valve is driven to rotate, thereby controlling the opening degree of the flow valve.

As shown in FIG. 4, a rotating portion of the valve handle is provided with a toggle rod extending outwards, a tail end of the toggle rod abuts against a microswitch that controls the electric pump, and the microswitch has a fixed end and a movable end.

The microswitch is a switch that controls whether the electric pump operates or not. The microswitch has a movable end and a fixed end. In this embodiment, one end of the microswitch is provided with a pin, the pin is connected to a battery through an electric wire, and the other end of the microswitch is provided with two inclined plate-shaped structures. One ends of the two plate-shaped structures overlap to form the fixed end, which is fixed to one side of the microswitch and cannot move. The two plate-shaped structures are inclined at different angles, so that the other ends of the two plate-shaped structures are slightly away from a main body of the microswitch and can move under pressure to form the movable end. When the movable end is pressed, a contact inside the microswitch is closed, and a circuit is connected. When the movable end is released, the contact is automatically opened, and the circuit is disconnected.

A part of the valve handle inside the housing of the tube-end sprayer is provided with a rod-shaped toggle rod. The toggle rod can rotate along with rotation of the valve handle. The valve handle and the toggle rod rotate coaxially at the same rotation angle. The toggle rod abuts against the microswitch that controls whether the electric pump starts. In an original state of the valve handle, the flow valve is closed, and the opening degree is zero. At this time, the toggle rod abuts against an edge of the fixed end of the microswitch. When the valve handle rotates to open the flow valve and drive the toggle rod to rotate, the toggle rod rotates from the fixed end of the microswitch towards the movable end of the microswitch, and the movable end of the microswitch is pressed, so that the microswitch is connected, and the electric pump starts. When the valve handle rotates to close the flow valve and drive the toggle rod to rotate, the toggle rod rotates from the movable end of the microswitch towards the fixed end of the microswitch. When the valve handle rotates to close the flow valve, the toggle rod also rotates to an end part of the fixed end of the microswitch, so that the microswitch is disconnected, and the electric pump also shuts down accordingly.

The design of the cooperation between the toggle rod on the valve handle and the microswitch not only can enable the diluted liquid and the preparation to flow into the tube-end sprayer simultaneously, but also can control the inflow volume of the diluted liquid. Based on pumping of a fixed amount of the preparation by the electric pump, different dilution ratios can be achieved to meet the requirements of more application scenarios.

One end of the spray outlet is provided with a long-handled pipeline connected to the output end of the flow valve, so that the output end of the flow valve communicates with the liquid mixing chamber. The spray outlet is trumpet-shaped, and a small-diameter end of the spray outlet is provided with a long-handled pipeline extending outwards. From one side close to the flow valve to one side close to the spray outlet, the diameter of a flow passage of the long-handled pipeline gradually decreases. This increases the flow velocity of the diluted liquid during flow, thus increasing the pressure. An outer surface of the long-handled pipeline is provided with a raised net-shaped structure, making the outer surface of the long-handled pipeline present a grid group. The long-handled pipeline is inserted into a tube at the output end of the flow valve, and the raised structure on the outer surface of the long-handled pipeline serves the functions of blockage and interference fit assembly, so that the flow valve is blocked and sealed while the output end of the flow valve communicates with a flow passage of the spray outlet.

As shown in FIG. 5, the microswitch that controls the electric pump is connected to a battery. A battery compartment is disposed at either end part of the housing of the tube-end sprayer, and a push-pull movable plate is disposed for blocking and closing. The movable plate is pushed or pulled to expose the battery compartment. In this embodiment, the battery includes two dry cells. The battery compartment is horizontally disposed at the bottom of the electric pump, so that the housing of the tube-end sprayer presents a transverse bending portion. A contact end of the dry cell is connected to the electric wire of the microswitch inside the housing of the tube-end sprayer. A plate-shaped structure for snapping is disposed at the end part of the housing of the tube-end sprayer. The plate-shaped structure is in snap-fit connection with the movable plate, serving as a door of the battery compartment.

The above descriptions are only preferred embodiments of the present invention and are not used to limit the present invention. Any modifications, equivalent substitutions and improvements, etc. made within the spirit and principle of the present invention shall be included within the scope of protection of the present invention.

What is claimed is:

1. A tube-end sprayer, comprising a spray outlet provided with a liquid mixing chamber, wherein the liquid mixing chamber has an output port facing an output port of the spray outlet, one input port communicating with an electric pump, and the other input port communicating with a flow valve, the flow valve communicates with a hose that delivers a diluted liquid, and the electric pump communicates with a liquid container that holds a preparation.

2. The tube-end sprayer according to claim 1, wherein the electric pump is a metering pump.

3. The tube-end sprayer according to claim 1, wherein flow directions of liquids flowing into the liquid mixing chamber through the two input ports are perpendicular to each other.

4. The tube-end sprayer according to claim 1, wherein the electric pump is disposed above the spray outlet, and the liquid container that holds the preparation is disposed below the spray outlet.

5. The tube-end sprayer according to claim 4, wherein a liquid accommodation chamber of the electric pump is disposed at a lower part, and a driving portion of the electric pump is disposed at an upper part.

6. The tube-end sprayer according to claim 1, wherein an end part of the tube-end sprayer connected to the hose is provided with a first plug, and the first plug is connected to a nut; and an end part of the tube-end sprayer connected to the liquid container is provided with a second plug, and the second plug is connected to a nut.

7. The tube-end sprayer according to claim 1, wherein the flow valve is provided with a valve handle that controls an opening degree of a flow passage of the flow valve, and the valve handle is connected to a valve element of the flow valve.

8. The tube-end sprayer according to claim 7, wherein a rotating portion of the valve handle is provided with a toggle rod extending outwards, a tail end of the toggle rod abuts against a microswitch that controls the electric pump, and the microswitch has a fixed end and a movable end.

9. The tube-end sprayer according to claim 1, wherein a microswitch that controls the electric pump is connected to a battery.

10. The tube-end sprayer according to claim 1, wherein one end of the spray outlet is provided with a long-handled pipeline connected to an output end of the flow valve, so that the output end of the flow valve communicates with the liquid mixing chamber.
